(19) United States
(12) Patent Application Publication
(10) Pub. No.: US 2025/0137943 A1
(43) Pub. Date: May 1, 2025

(54) PROTECTIVE EQUIPMENT QUALITY CONTROL

(71) Applicant: CARESTREAM HEALTH, INC., Rochester, NY (US)

(72) Inventors: Luca BOGONI, Philadelphia, PA (US); Xiaohui WANG, Pittsford, NY (US)

(21) Appl. No.: 18/922,494

(22) Filed: Oct. 22, 2024

Related U.S. Application Data
(60) Provisional application No. 63/592,934, filed on Oct. 25, 2023.

(51) Int. Cl. G01N 23/04; G01N 23/083; G21F 3/03

(52) U.S. Cl. CPC G01N 23/04; G01N 23/083; G01N 2223/3303; G01N 2223/401; G01N 2223/408; G21F 3/03

(57) ABSTRACT

Apparatus and method for disposing a human worn apron, which is at least partially constructed of a radiopaque material, between an x-ray source and a digital radiographic detector. Radiographic images of the human worn apron are captured in the detector after exposure by the radiographic source so that the radiographic images may be examined to identify gaps or areas that may be worn out or eroded in the radiopaque material.

### CROSS REFERENCE TO RELATED APPLICATIONS

This application claims priority to U.S. Patent Application Ser. No. 63/592,934, filed Oct. 25, 2023, in the name of Bogoni et al., and entitled PROTECTIVE EQUIPMENT QUALITY CONTROL, which is hereby incorporated by reference herein in its entirety.

### BACKGROUND OF THE INVENTION

The subject matter disclosed herein relates to protective equipment that is worn during radiographic imaging. In particular, to testing the protective equipment for defects using standard x-ray equipment.

Lead aprons 100, such as shown in FIG. 1, are used to protect practitioners from radiation (direct or from back scattering) when performing radiographic examinations. Such aprons 100 may include radiopaque materials, which may include lead sheets, lead based layers, or other radiopaque materials, sewn in or otherwise attached within a fabric comprising the main apron material that is worn by a radiography technician. The apron 100 may include a radiopaque neck area 101 for protecting the neck area of the technician from emitted x-rays; a radiopaque shoulder area 103 for protecting the shoulder area of the technician from emitted x-rays; a radiopaque chest area 105 for protecting the chest are of the technician from emitted x-rays; and a radiopaque abdominal area 107 for protecting the abdominal area of the technician from emitted x-rays. Side straps may be included to be tied behind the technician for securing the apron 100 in position. After frequent and repetitive use over time aprons 100 may crack or develop various types of defects. While defects may be noticeable following quick visual inspection, wear and tear of the underlying radiopaque material may or may not be visible thus undermining protection and leaving the wearer vulnerable to harmful radiation. For this reason, institutions have developed protocols for inspections to safeguard the integrity of the protective equipment and for quality control. Criteria for when the protective equipment may no longer be used may include length and width of cracks or slashes, size of holes, as well as locations of such defects. Protocols may include multiple types of inspections to be performed annually or as visual defects are observed.

Radiological inspections are presently performed periodically as mandated in most states in the US. The inspections may consist of laying the protective equipment on a radiolucent table, then using a fluoroscopic imaging system to interactively expose the lead apron region by region repeatedly with the intent of making sure that the entire are of the protective equipment is radiographically imaged. Visual inspections of the individual images are performed in the meanwhile. Such a process is not only laborious and operator dependent, but might inadvertently miss portions of the protective equipment and impose radiation risk to the inspector. Furthermore, a minor defect might warrant only a reporting and allow the protective equipment to be continuously used. Proper localization in follow up examination with different images acquired at different angles and covering different areas might lead to difficulties in locating the reported defect and further complexities in measuring any change. Subjective and manual engagement could lead to erroneous assessments.

The discussion above is merely provided for general background information and is not intended to be used as an aid in determining the scope of the claimed subject matter.

### BRIEF DESCRIPTION OF THE INVENTION

Apparatus and method for disposing a human worn apron, which is at least partially constructed of a radiopaque material, between an x-ray source and a digital radiographic detector. Radiographic images of the human worn apron are captured in the detector after exposure by the radiographic source so that the radiographic images may be examined to identify gaps or areas that may be worn out or eroded in the radiopaque material.

In one embodiment, a disclosed method includes placing a human worn apron made of, at least in part, radiopaque material between an x-ray source and a digital radiographic detector. Radiographic images of the human worn apron are acquired and the images examined to identify gaps, defects or worn out areas in the radiopaque material.

In one embodiment, an apparatus for radiographically imaging a human worn apron includes an x-ray source, a digital x-ray detector, and a rack for holding the human worn apron between the x-ray source and the digital x-ray detector while the apron is in an unfolded position.

The present invention introduces a device and a procedure to automate the radiological inspection of protective radiography apparel using standard x-ray equipment available in digital radiography (DR) rooms. This innovation introduces a method to leverage existing DR equipment and is predicated on performing the following steps:
1. Use equipment already available in DR Room, namely a motor driven moveable bucky and motor driven moveable x-ray tube head. These components either move automatically in synchronicity so that the field of view of the x-ray aligns with the bucky (which contains the DR detector) or are manually aligned by the technologist.
2. Place the protective equipment worn by the medical personnel in between the DR detector and tube-head.
3. Systematically fully acquire x-ray images of the complete protective equipment.
4. Perform an analysis of the acquired images to identify any defects.

The present invention discloses various embodiments of these steps and combinations thereof. With respect to step 2, the present invention introduces two embodiments of accessory devices, such as an apron rack, to hang protective (shielding) equipment worn by medical personnel. Step 3 may be defined in conjunction with the automation capabilities of step 1. These range from fully automatic to manual. Once images are acquired, the images can be composed to form a single stitched image as well as other representations to facilitate the archival, review, and analysis (manual or automated) to enable quality control of the protective equipment. As each device has a unique device ID, the images can be delivered to a picture archiving and communication system (PACS) workstation for reviewing at the PACS, similarly to how patient images are sent to PACS for diagnosis. Diagnostic reports for the review of the x-ray images of protective equipment can be generated and stored in the hospital radiology information system (RIS). The reports, which serve as a device history record, can be pulled from RIS for monitoring testing compliance, proactive surveillance testing, longitudinal comparison and obsolescence monitoring.

Without loss of generalization, the description herein will be primarily articulated with respect to lead aprons, although it is to be understood that the accessory as well as the methodology may be applied to protective equipment that is made from other materials and may be larger than can be captured with a single x-ray exposure. The present invention also introduces additional automated solutions aimed at automating detection of defects and longitudinal comparisons for personal shielding equipment which are small enough to fit into a single x-ray image.

The summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings below are intended to be drawn neither to any precise scale with respect to relative size, angular relationship, relative position, or timing relationship, nor to any combinational relationship with respect to interchangeability, substitution, or representation of a required implementation., emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 illustrates an exemplary lead apron used by medical staff, such as a radiologist, that includes a neck guard and side straps to be tied behind the staffer;

FIG. 2 shows an embodiment of an accessory for hanging a lead apron to be radiographically imaged, which includes a rack similar to a clothes rack, that is vertically and horizontally extendable;

FIGS. 3A-3C illustrates an alternative accessory, or rack, for hanging an apron to be radiographically imaged;

FIGS. 4A-4B illustrate an image acquisition process in which an automated process moves the x-ray source through vertical positions in correspondence to a wall bucky (FIG. 4A), while another automated process involves tilting, or rotating, the source up and down while the wall bucky moves vertically through corresponding positions (FIG. 4B);

FIGS. 5A-5B illustrate an image acquisition process corresponding to the processes of FIGS. 4A-4B, respectively, where several image areas (c₁₋₂×r₁₋₃) are acquired by a vertical scanning process for a set of locations corresponding to different tube-head locations or tilt angles (p₁-p₃) shown on the right; and

FIG. 6 illustrates plan development for acquisition of x-ray images based on image analysis of the shape of the protective equipment from an RGB image.

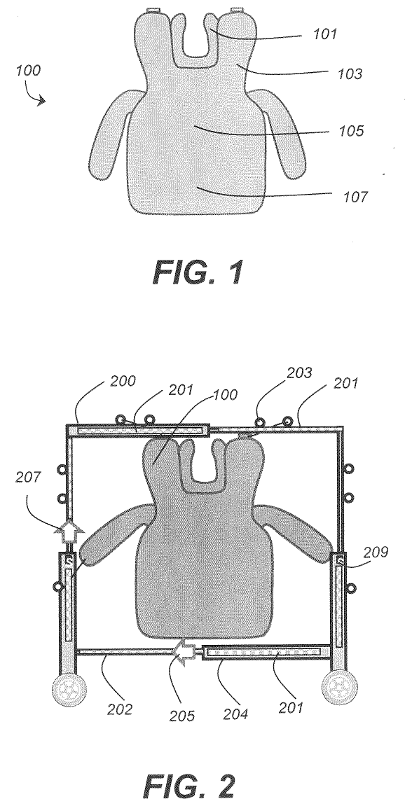

### DETAILED DESCRIPTION OF THE INVENTION

With reference to FIG. 2, in one embodiment, an accessory device for facilitating systematic acquisition of x-ray imaging of protective equipment in the form of an apron 100 includes a means, such as a wheeled rack 200 to hang the protective equipment (lead-apron 100) so that it is positioned unfolded and generally in a plane perpendicular to the floor so that it is fully unfolded, extended and exposed for x-ray image acquisitions.

Although the embodiments described herein of the accessory devices have different appearance, they may include common characteristics, such as alignment patterns 201 disposed on the frame of the rack 200 on frame portions 202, 204, and other portions, for example. These alignment patterns are disposed so as to be visible to one or more RGB depth cameras 404 (FIG. 4A) included with a radiographic imaging system used to image the protective apron 100. These alignment patterns may be used to determine the orientation of the plane of accessory rack 200, or the size of the accessory rack 200. The alignment patterns are also configured to be detectable in the x-ray images of the apron 100, because lead aprons and protective equipment tend to be rather poor in texture and the alignment patterns may help in aligning the acquired x-ray images of the apron 100. Aligning x-ray images using the alignment patterns not only affords creating a complete composite of the protective equipment but guarantees that no part of the protective equipment is missed in the acquisition process. The rack 100 may include several loops 203 around its periphery that may be tied to the apron 100 for securing the apron 100 in an unfolded position for radiographic imaging. The rack 100 may include thin frame portions 202 and wider frame portions 204 so that the thinner frame portions 202 may slide out of the wider frame portions 204 in a horizontal direction 205 and vertical direction 207 so that the rack 200 may be extended and be attached to different size aprons 100 and be used to extend the aprons 100 so that the aprons 100 are generally flat in a vertical plane perpendicular to a floor.

Depth sensors 209 may provide a capability to determine the spatial relation of the rack 200 to the plane of a bucky 402 (FIG. 4A) holding a digital radiographic detector 403 (FIG. 4A). The depth camera 404 may also be used to identify a size, location and orientation of the rack 200. As noted, the orientation of the plane of the rack 200 may be used to provide feedback to the technologist to align or adjust the positioning of the rack 200 holding the apron 100. In one embodiment, illustrated in FIG. 2, the rack 100 for hanging the lead apron 100 affords easy deployment and collapsible storage, containing alignment patterns 201 that are visible to an RGB camera as well as detectable on the x-ray images.

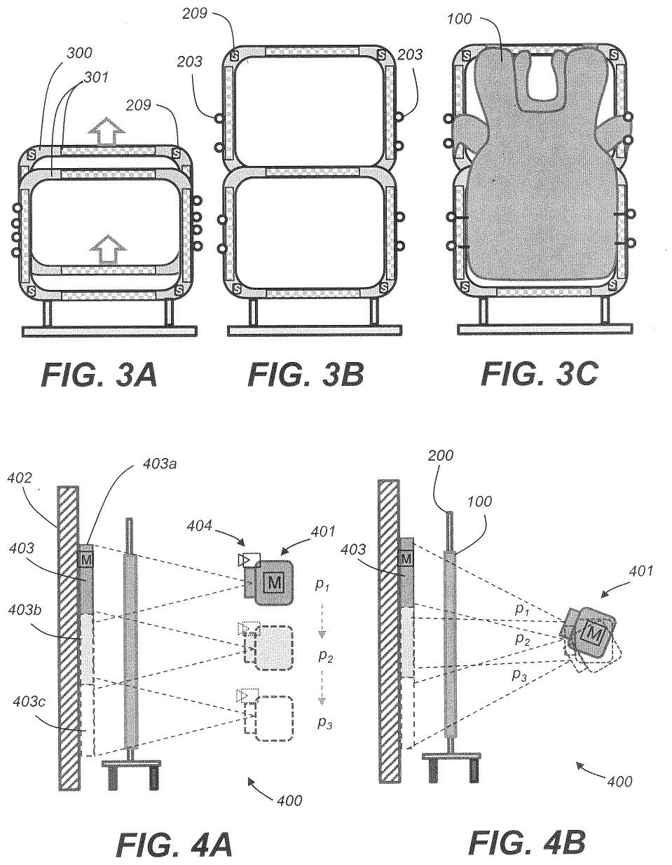

In an embodiment illustrated in FIGS. 3A-3C, a different type of hanging rack 300 is illustrated. The rack 300 includes two equivalent frames 301 that may be vertically extended, relative to each other, as shown by the arrows in FIG. 3A, and shown in an extended position in FIG. 3B. FIG. 3C illustrates that the rack 300 more closely fits the shape of the lead apron 100 while allowing for it to be supported fully flat to ensure that defects are exposed during x-ray image acquisition.

FIGS. 4A-4B illustrate exemplary acquisition procedures using a radiographic imaging system 400. FIG. 4A illustrates vertical movement of the X-ray source 401 to positions p₁-p₃ simultaneously with corresponding vertical movement of the digital radiographic detector 403 to positions 403a-403c. FIG. 4B illustrates tilting or rotating movement of the X-ray source 401 to three different angular position p₁-p₃ simultaneously with corresponding vertical movement of the digital radiographic detector 403 to the same positions 403a-403c as shown in FIG. 4A, to capture images of the apron 100 secured within apron rack 200. The DR detector 403 and x-ray source 401 may be moved by a controllable and/or programmable motor drive M. These procedures and apparatus are somewhat similar to acquisition protocols used in digital radiography to acquire full leg images of a patient as part of a single vertical scan long length image procedure, or of the spine that may use a long length digital detector or use a combined series of images. When combining a series of images, the tube-head moves simultaneously with a bucky holding the digital detector in a corresponding direction so as to enable the acquisition. These acquisitions rely on small overlapping portions to enable vertical image stitching. In this case, as the apron may be significantly wider than a typical patient, one or more vertical scans may be required.

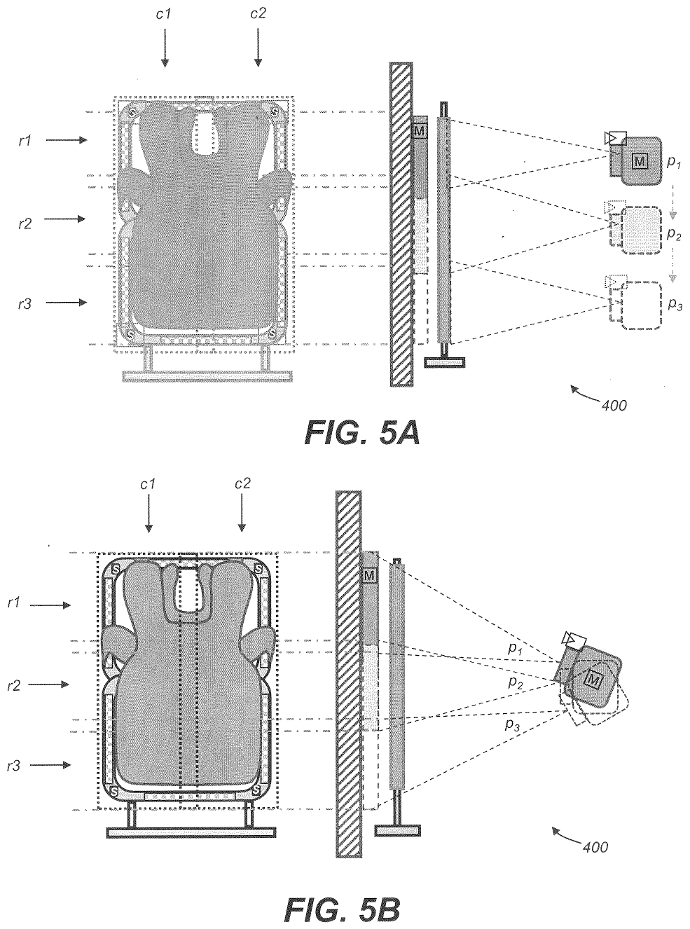

To acquire images of the full area of the apron 100, see the exemplary procedures shown in FIGS. 5A-5B, which are schematic diagrams of the image capture procedure shown in the radiographic imaging system movements of FIGS. 4A and 4B, respectively. Bucky functionality in this example includes a configuration for vertical as well as horizontal movement. In this process, acquired images may be obtained in corresponding rows and columns of images as shown by the arrows in these figures, which follow a columns alignment that may be identified as (c1, r1), (c1, r2), (c1, r3) followed by the second column c2, and so on. In such a scenario the subsequent vertical scans may be acquired systematically. If the bucky does not automatically displace horizontally, the technician may be required to translate the hanging rack horizontally to initiate the new vertical scan.

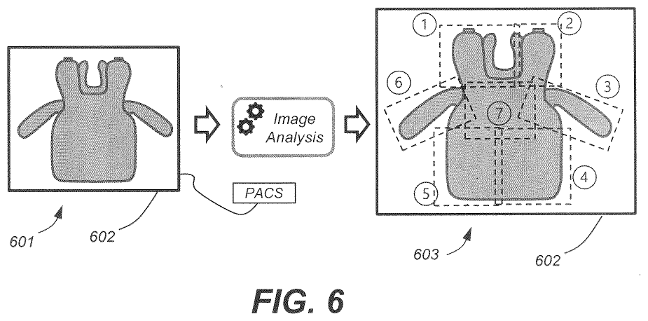

Overlays from an RGB acquired image in conjunction to a collimation light may be used as part of a user interface to guide the technician to properly align the hanging rack for the next vertical scan. In an additional embodiment of the radiographic imaging system 400, illustrated in FIG. 6, the protocol for image acquisition may be based on performing an analysis of an RGB camera image 601 of the protective equipment such as captured by RGB camera 404 and displayed on digital display 602. An electronic PACS system may be used to store and retrieve images captured by the radiographic imaging system 400 and be displayed on connected digital display 602. Image analysis may perform, for instance, a shape or contour extraction to identify a mask for the protective equipment and then, based on the controlling capabilities of the DR system, generate a geometric acquisition plan 603 for sequential image acquisitions which optimally combines tube-head position, and collimation windows so as to optimize the acquisition process as well as the integration process. The geometric acquisition plan 603 may include numbered areas to be radiographically imaged in numerical sequence by manually or automatically positioning the tube head and DR detector, and may also be displayed on the digital display 602.

Finally, the review of the images can be performed by a trained technician or radiographer or by having an automated and assisted process to detect defects. Depending on the nature and conspicuity of the defects, various actions could be taken. In the event that there are no defects or defects are deemed minor and hence passable, longitudinal review may be performed either manually or having an automated process of: registering the collections of the x-ray images; matching any of the defects or identifying new ones; and computing any changes and, based on the severity of the change, determining a potential point of failure for the protective equipment.

Note that defects may include not only cracks and holes in the apron 100 but also thinning of the material. While the present discussion has been focused on having the procedure performed using DR room equipment so as to automate the process, similar approaches can be performed using a portable tube-head and a bucky while applying the strategy and systematic approach herein described.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
disposing a human worn apron, the apron comprising radiopaque material, between an x-ray source and a digital radiographic detector;
acquiring radiographic images of the human worn apron; and
examining the radiographic images to identify gaps in the radiopaque material.

2. The method of claim 1, further comprising disposing the human worn apron in a rack configured to secure the human worn apron in an unfolded position between the x-ray source and the digital radiographic detector.

3. The method of claim 1, further comprising constructing the human worn apron with the radiopaque material in a chest area of the human worn apron.

4. The method of claim 3, further comprising constructing the human worn apron with the radiopaque material in a neck area of the human worn apron.

5. The method of claim 4, further comprising constructing the human worn apron with the radiopaque material in an abdominal area of the human worn apron.

6. The method of claim 5, further comprising acquiring radiographic images of the chest area, the neck area, and the abdominal area of the human worn apron.

7. The method of claim 1, further comprising determining a plurality of areas of the apron to be radiographically acquired in a predetermined sequence.

8. The method of claim 1, further comprising capturing an array of c×r images of the apron, where c and r are each an integer greater than one.

9. The method of claim 8, further comprising stitching together the acquired images.

10. An apparatus for radiographically imaging a radiopaque human worn apron in an unfolded position, the apparatus comprising:
a moveable x-ray source;
a moveable digital x-ray detector; and
a rack for securing in the unfolded position the human worn apron between the x-ray source and the digital x-ray detector.

11. The apparatus of claim 10, further comprising a motor drive for moving the x-ray source to different positions relative to the secured human worn apron to radiographically capture images of different areas of the human worn apron.

12. The apparatus of claim 11, wherein the different areas of the human worn apron include a neck area, a chest area and an abdominal area.

13. The apparatus of claim 11, further comprising an image storage system connected to the apparatus for storing and retrieving radiographic images of the human worn apron.

14. The apparatus of claim 11, further comprising a camera for capturing an image of the human worn apron wherein the different areas of the human worn apron are selected for radiographic imaging in a predetermined sequence.

15. The apparatus of claim 14, further comprising a digital display for displaying the different areas of the human worn apron selected for radiographic imaging.
